(19) United States
(12) Patent Application Publication
(10) Pub. No.: US 2003/0217051 A1
(43) Pub. Date: Nov. 20, 2003

(54) Information retrieving apparatus and storage medium storing information retrieving software therein

(76) Inventors: Masao Uchiyama, Tokyo (JP); Hitoshi Isahara, Tokyo (JP)

Correspondence Address: BIRCH STEWART KOLASCH & BIRCH, PO BOX 747, FALLS CHURCH, VA, 22040-0747, US

(21) Appl. No.: 10/419,772

(22) Filed: Apr. 22, 2003

(30) Foreign Application Priority Data
Apr. 23, 2002 (JP) 2002-120531

(51) Int. Cl. G06F 7/00

(52) U.S. Cl. 707/3

(57) ABSTRACT

To present appropriate characteristic terms to a searcher with respect to an arbitrary retrieval term, and provide an efficient information retrieving method.

An index database 12 is constructed in advance from information in various storage media 10 and 11 so as to extract characteristic terms associated with a keyword 3 input by the searcher from the index database. Information retrieving is performed in a high-speed and convenient manner by presenting the characteristic terms to the searcher so as to cause the searcher to designate the characteristic terms.

### BACKGROUND OF THE INVENTION

1. Field of the Invention

The present invention relates to an information retrieving apparatus and a recording medium storing an information retrieving software therein in a computer, and particularly to a technique specific to an information retrieving method.

2. Description of the Related Art

Commercialization of the Internet or Intranet has been promoted in recent years, and the amount of information accumulated therein has been dramatically increased. A service called a retrieval site has been provided in order to perform information retrieval from a vast amount of information, and development of a search engine is advanced in order to perform high-speed and effective retrieval.

As a technique for efficiently retrieving information, for example, Japanese Patent Application Laid-Open No. 2002-73655 discloses a technique for designating a plurality of labels to retrieve information resources associated thereto, in which, among the labels associated to the information resources retrieved with the designated label as a retrieval key, labels other than the labels designated as the retrieval key are displayed as candidates of retrieval key when next retrieving, and labels selected from the displayed candidates of retrieval key are added to the retrieval key to update the retrieval key so that an information resource is retrieved.

In the above method, selecting of a label for narrowing retrieval can be easily performed, which contributes to that efficient retrieval of information resource is enabled. However, since a table which associates a retrieval key and candidates of the retrieval key, such as labeling table or label table in this disclosure, has to be prepared in advance, although a certain effect can be expected for a predicted retrieval key, a large number of tables as described above are required in order to realize an arbitrary information retrieving method, which is difficult in reality.

### SUMMARY OF THE INVENTION

The present invention has been made in terms of the above problem in the conventional technique, and it is therefore an object of the present invention to provide an efficient information retrieving method by presenting appropriate characteristic terms to a searcher with respect to arbitrary retrieval terms.

The present invention devises the following information retrieving apparatus in order to solve the above problem.

That is, an information retrieving apparatus for searcher's retrieving desired information from information recorded in an information recording medium comprises retrieval term inputting means, characteristic term extracting means for automatically extracting one or a plurality of characteristic terms associated with the retrieval term from the information recording medium, characteristic term designating means for searcher's designating at least one of the characteristic terms, term incorporating means for incorporating the designated characteristic term into a retrieval term, and retrieving means for extracting one or a plurality of items of information retrieved from all the retrieval terms.

Alternatively, the information retrieving apparatus may comprise retrieval display means which is configured with a retrieval term display section for displaying a retrieval term which is designated by the retrieval term inputting means and/or incorporated by the term incorporating means, a characteristic term display section for displaying a characteristic term extracted by the characteristic term extracting means, a header display section for displaying a header of one or a plurality of items of information retrieved by the retrieving means, and a detail display section for displaying details of one or a plurality of items of information retrieved by the retrieving means.

The information retrieving apparatus may be configured such that the retrieval display means is a computer monitor, and that, in a configuration where the retrieval display means is displayed on the computer monitor in a divided manner into substantially right and left sides, the retrieval term display section, the characteristic term display section, and the detail display section are arranged at the upper, intermediate, and lower stages, respectively, in the substantially left side, while the header display section is arranged in the substantially right side.

Here, the information retrieving apparatus may be configured such that the characteristic term display section has a plurality of columns so that a plurality of characteristic terms can be displayed for each column, and each characteristic term is distributed and displayed in each column for each attribute of the characteristic term.

At this time, part of speech may be used as an attribute of the characteristic term so that distribution and display is performed by part of speech.

The information recording medium may be at least one of a hard disk, a digital video disk, a compact disk, a floppy disk, a magnetooptical disk, a magnetic tape, a semiconductor memory installed in a server provided on the Internet.

Alternatively, the information recording medium may be at least one of a hard disk, a digital video disk, a compact disk, a floppy disk, a magnetooptical disk, a magnetic tape, a semiconductor memory installed in the information retrieving apparatus.

Further, according to the present invention, there may be provided a storage medium storing an information retrieving software for searcher's retrieving desired information from information recorded in an information recording medium.

The information retrieving software comprises a retrieval term inputting step, a characteristic term extracting step of automatically extracting one or a plurality of characteristic terms associated with the retrieval term from the information recording medium, a characteristic term designating step of searcher's designating at least one of the characteristic terms, a term incorporating step of incorporating the designated characteristic term into a retrieval term, and a retrieving step of extracting one or a plurality of items of information retrieved from all the retrieval terms.

Further, the information retrieving software may comprise a retrieval display step of displaying a retrieval term which is designated in the retrieval term inputting step and/or incorporated in the term incorporating step in a retrieval term display section, displaying a characteristic term extracted in the characteristic term extracting step in a characteristic term display section, displaying a header of one or a plurality of items of information retrieved in the retrieving step in a header display section, and displaying details of one or a plurality of items of information retrieved in the retrieving step in a detail display section.

In a configuration where division display is performed into substantially right and left sides on a computer monitor by the retrieval display step, there may be configured such that the retrieval term displays section, the characteristic term display section, and the detail display section are arranged at the upper, intermediate, and lower stages, respectively, in the substantially left side, while the header display section is arranged in the substantially right side.

The storage medium may be configured such that the characteristic term display section has a plurality of columns so that a plurality of characteristic terms can be displayed for each column, and each characteristic term is distributed and displayed in each column for each attribute of the characteristic term.

At this time, part of speech may be used as an attribute of the characteristic term so that distribution and display is performed by part of speech.

In the above, the information recording medium may be at least one of a hard dist, a digital video disk, a compact disk, a floppy disk, a magnetooptical disk, a magnetic tape, a semiconductor memory installed in a server provided on the Internet.

Alternatively, the information recording medium may be at least one of a hard disk, a digital video disk, a compact disk, a floppy disk, a magnetooptical disk, a magnetic tape, a semiconductor memory installed in an apparatus in which an information retrieving software is introduced.

### BRIEF DESCRIPTION OF THE DRAWINGS

FIG. 1 is a configuration diagram of an information retrieving apparatus according to the present invention;

FIG. 2 is an explanatory diagram showing one example of an index database; and

FIG. 3 is an explanatory diagram showing a monitor screen of the information retrieving apparatus according to the present invention.

### DETAILED DESCRIPTION OF THE PREFERRED EMBODIMENT

Hereinafter, a method for implementing the present invention will be described on the basis of an embodiment shown in the drawings. In addition, the embodiment according to the present invention is not limited to the following, and can be appropriately modified.

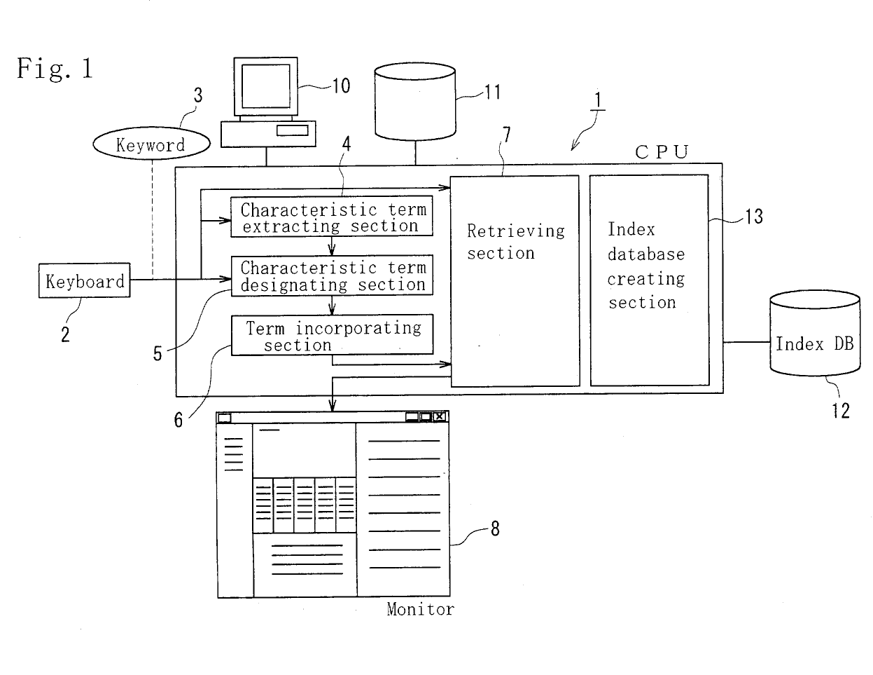

FIG. 1 is an explanatory diagram of an information retrieving apparatus (hereinafter, referred to as the present apparatus) (1) according to the present invention. The present apparatus (1) can be easily realized by introducing a software into, for example, a personal computer generally distributed.

A searcher uses a keyboard (2) to input a desired keyword (3). In a conventional search engine, for example URL of WWW (World Wide Web) matched with the keyword or the like has been retrieved according to the keyword, and displayed.

However, along with increase in information resources, it has become difficult to obtain a retrieval result which the searcher truly requires in this method, so that there is a problem that it is hard to know how to perform effective narrowing according to which keyword.

Therefore, according to the present invention, there is developed the apparatus (1) for enabling efficient retrieval when performing information retrieval from a storage medium (10) in an external server or storage medium (11) installed in the present apparatus, wherein for example text data or HTML (hyper text markup language) data accumulated in each storage medium (10), (11) in advance is analyzed, an index is created and recorded in an index database (12), characteristic terms associated with the keyword (3) input by the searcher are extracted from the index database (12) to be presented to the searcher.

The index database (12) is created in an index database creating section (13), and an index can be created for each text data using a well-known morphological analysis technique. (A morphological analysis tool includes, for example, “chasen” by Matsumoto, Kitauchi, Yamashita, Hirano, Matsuda, Takaoka, and Asahara, 2001 in http://chasen.aist-nara.ac.jp/, and “JUMAN” in http://www-lab25.kuee.kyoto-u.ac.jp/nl-rsource/juman.html, and the like.)

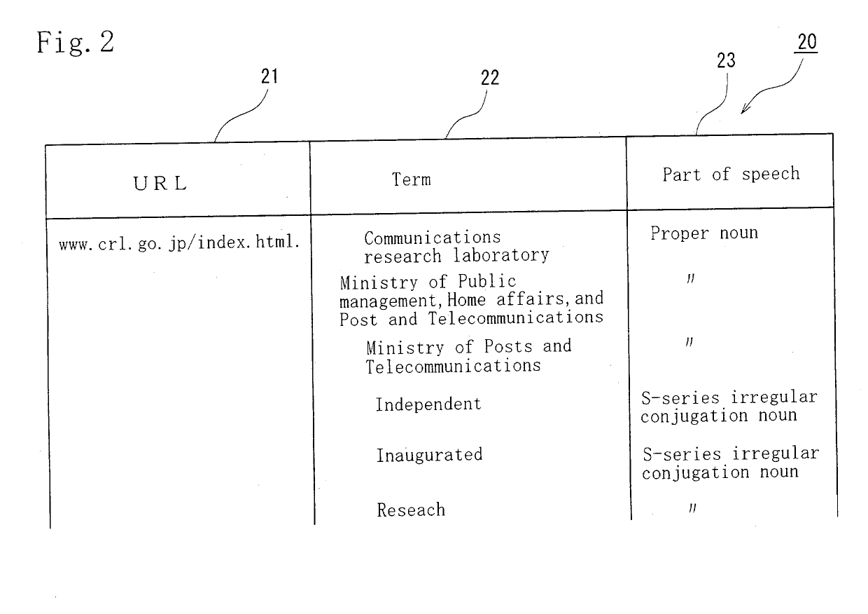

The index database 12 is configured so that terms which are contents of a table (20) shown in FIG. 2 are standardized for URL (21), and terms (22) which are mainly noun are extracted to be recorded together with information of part of speech (23).

For example, the example shown in FIG. 2 is extracted from HTML data contained in the WWW site (www.crl.go.jp) describing “In April 2001, the Communications Research Laboratory became independent of the Ministry of Public management, Home affairs, and Posts and Telecommunications (formerly the Ministry of Posts and Telecommunications) and was newly inaugurated as an independent administrative institution designated the “Communications Research Laboratory”. CRL's diversified research themes, including the core subject of communications, are conducted in the following four divisions.”

The index database creating section (13) according to the present invention automatically circulates the data accumulated in each storage medium (10), (11) at a predetermined timing to construct the index database (12). Such an automatic circulating method may employ an arbitrary technique, and a circulation period, timing, and the like thereof are arbitrary.

In the present embodiment, the HTML data or text data in the WWW site is displayed, but a retrieval target in the present invention may have any form of data, and does not require human legibility and visibility as far as the data is identifiable in a computer. Further, the index database (12) may be recorded in the same medium as the above storage medium (11).

There is provided the apparatus (1) which contributes to efficient retrieval and is capable of easily performing selection from the presented terms with a classifying method when terms associated with the keyword (3) are presented to the searcher.

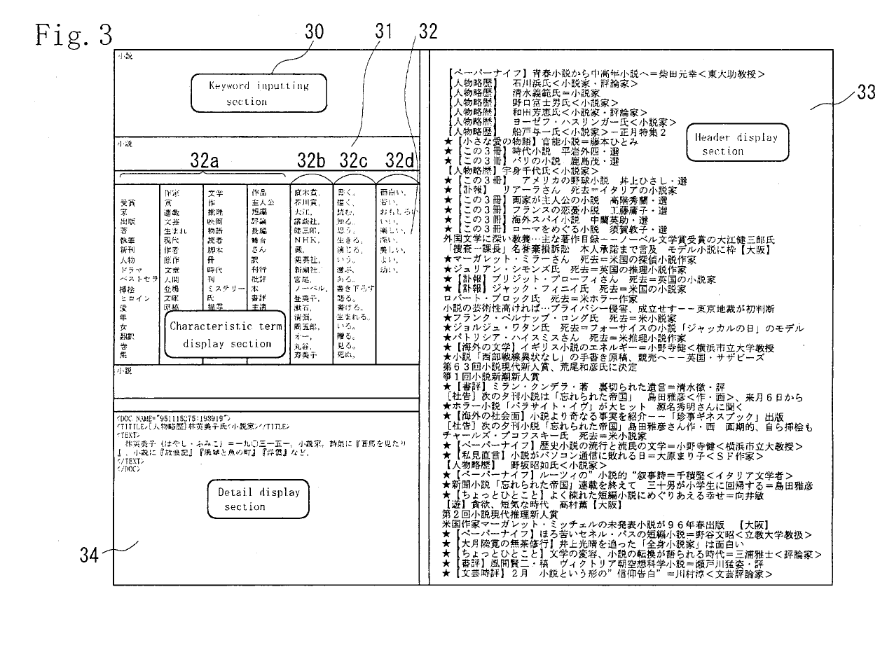

As one example of the presenting method, a display screen in a monitor (8) in the present apparatus (1) is shown in FIG. 3.

The keyword (3) input by the searcher from the keyboard (2) is displayed in a keyword inputting section (30) on the monitor (8). All the keywords being currently retrieved are indicated in the lower stage (31) thereof.

According to the present embodiment, description will be made assuming that the keyword (3) of “novel” is given and the searcher performs narrowing.

A characteristic term extracting section (4) in the CPU extracts characteristic terms associated with the keyword from the index database (12) on the basis of the keyword (3).

A processing in the characteristic term extracting section (4) can employ an arbitrary extracting method, but, for example, a term having a large log likelihood ratio can be extracted as a characteristic term for the keyword to be retrieved.

The log likelihood ratio λ is a likelihood ratio by the maximum likelihood estimator between the case where the two words of v and w are dependent and the case where the two words are independent. As the two words are more dependent, the log likelihood ratio has a larger value.

A definitional equation is expressed by equation 1:

$$\ddot{e} = 2 {\sum }_{i , j} {f}_{i j} \{ log \frac{{f}_{i j}}{F} - log \frac{{f}_{i } {f}_{j}}{{F}^{2}} \} \qquad ( Equation 1 )$$

where, f (v, w) denotes the number of documents where the words v and w appear together, f(x) denotes the number of documents where the word x appears, and F denotes the total number of documents,

f₁₁=f(v, w)

f₁₂=f(v)−f(v,w)

f₂₁=f(w)−f(f,w)

f₂₂=F−f₁₁−f₁₂−f₂₁

is obtained. Further,

fᵢ=fᵢ₁+fᵢ₂

fⱼ=f₁ⱼ+f₂ⱼ

is obtained.

As an example of characteristic term extraction using such a log likelihood ratio, a result where ten characteristic terms of the keyword “retrieval” are extracted from data of a newspaper article is shown in a table 1. In addition, cooccurrence frequency in the table corresponds to the above f(v,w).

TABLE 1

| | Cooccurrence | |
|---|---|---|
| Characteristic term | frequency | Log likelihood ratio |
| Personal computer | 93 | 545.2879841 |
| Information | 148 | 444.5491541 |
| Database | 50 | 423.100068 |
| Computer | 68 | 343.9604411 |
| Utilization | 97 | 326.3583694 |
| Communication | 79 | 312.2293554 |
| CD-ROM | 33 | 263.1316569 |
| Electronic | 51 | 260.213618 |
| System | 68 | 236.7180314 |
| Data | 55 | 233.8312139 |

In this manner, in the characteristic term extracting section (4), the characteristic terms of “personal computer”, “information”, “database”, and the like associated with “retrieval” can be efficiently extracted as characteristic terms using the log likelihood ratio, alternatively terms having a higher cooccurrence frequency or appearance frequency may be extracted.

In the present apparatus (1), the extracted characteristic terms are displayed in the characteristic term display section (32) positioned in the left from the substantial center on the monitor (8) to wait designation by the searcher.

In the display, the characteristic terms are displayed in a categorized manner, which contributes to that the searcher can easily perform designation.

In the present embodiment, there is configured so that, for example, 126 terms in total of seven columns×18 rows are displayed in the form of list at maximum, and categorizing by parts of speech is performed so that four columns (32a) from the left are for common noun, the fifth column (32b) from the left is for proper noun, the sixth column (32c) from the left is for verb, and the seventh column (32d) from the left is for adjective.

As shown in FIG. 3, it is found that characteristic terms associated with a novel, such as common nouns such as “award winning”, “-ist (novelist)”, proper noun such as “Naoki Award”, a verb such as “write”, and an adjective such as “interesting”, are preferably extracted, for example, with respect to the keyword of “novel”.

Here, the characteristic terms are categorized by parts of speech, but a thesaurus or the like may be used to obtain semantic feature, thereby categorizing the characteristic terms. Further, when data including a plurality of languages is retrieved, it is possible to employ an arbitrary categorizing method depending on a retrieval target, such as categorizing by languages, categorizing by character types, or the like. Furthermore, the method may be dynamically changed by automatically determining the retrieval target.

The configuration of the characteristic term display section (32) can be arbitrarily changed, and can be set according to the categorizing method or the size of the monitor. Particularly, the retrieving method according to the present invention is characterized by designation by a searcher from the characteristic terms, so that it is desirable that the characteristic term display section (32) is arranged so as to occupy at least 20% of the area of the retrieval screen for convenient designation.

The searcher designates terms matched with his/her retrieval target from the displayed characteristic terms using the keyboard (2) or a mouse (not shown).

The designated characteristic terms are added to the already input keywords by the term incorporating section (6) of the CPU. Retrieving is performed again by all the keywords at the same time with designation.

When the searcher inputs a keyword in the keyword inputting section (30), the associated characteristic terms are displayed in the immediately lower stage at the same time and the searcher can easily designate the characteristic terms, so that preferable retrieving can be performed.

A header display section (33) is arranged over substantially all the rows in the right side of the monitor (8), which always displays a retrieval result according to a keyword.

In the header display section (33), part of document of text data or HTML data is displayed by one line from the keyword input by the keyboard (2) or the keyword incorporated by the term incorporating section (6).

A portion displayed as a header in the text data or HTML data may be a portion designated by a <TITLE> tag in the case of, for example, HTML data, or may be a title of other data. Further, surroundings of the portion which matches with the keyword may be displayed.

A display order in the header display section (33) is arbitrary, but it is preferable to display in descending order of degree of matching with the keyword, such as in descending order of included keywords in one item of data, in descending order of added value of the log likelihood ratio of the displayed data, or the like.

According to the present invention, in this manner, the header display section is arranged over all the rows substantially at the right side so that a large number of items of data matched with the keyword can be displayed in the list, which contributes to improvement of retrieval efficiency by the searcher.

Further, the searcher determines whether or not the data matches with the desired information from the header display section (33), and designates the header by the keyboard (2) or the mouse, so that the retrieval result can be displayed in a detail displays section (34).

The detail display section (34) may display the text data or HTML data in the form of text or by WWW browser. Further, the data to be retrieved is arbitrary so that the present invention can comprise a display function corresponding to the data.

As described above, the present invention can be implemented as the retrieving apparatus (1) using the personal computer, or can be distributed by a storage medium storing a software used for an arbitrary computer therein.

Keyword inputting means is not limited to the keyboard, and may arbitrarily employ, for example, a touch panel, a mouse, speech inputting through a speech recognition device, or the like, so that, even when a characteristic term is designated, such inputting means can be used.

Further, the external server comprising the storage medium (10) retrieved by the present apparatus (1) is preferably connected via the Internet or Intranet, and can be retrieved from one or a plurality of servers on the network.

Furthermore, the storage (11) installed in the present apparatus may be used together.

As the storage medium (10), (11), there can be employed, particularly a hard disk, a digital video disk, a compact disk, a floppy disk, a magnetooptical disk, a magnetic tape, a semiconductor memory.

The present invention has the above configuration, and obtains the following effects.

That is, the searcher inputs a desired keyword so that characteristic terms associated with the keyword is presented, which enables to efficiently narrow the characteristic terms. Thereby, it is possible to provide an information retrieving apparatus capable of high-speed and simple retrieval for a large amount of information on the Internet or the like.

Further, according to the present invention, a software having the above function is stored in the storage medium to be distributed, so that similar effects can be obtained in various computers.

What is claimed is:

1. An information retrieving apparatus for searcher's retrieving desired information from information recorded in an information recording medium, comprising:
retrieval term inputting means;
characteristic term extracting means for automatically extracting one or a plurality of characteristic terms associated with the retrieval term from the information recording medium;
characteristic term designating means for searcher's designating at least one of the characteristic terms;
term incorporating means for incorporating the designated characteristic term into a retrieval term; and
retrieving means for extracting one or a plurality of items of information retrieved from all the retrieval terms.

2. An information retrieving apparatus according to claim 1, comprising retrieval display means,
wherein the retrieval display means is configured with:
a retrieval term display section for displaying a retrieval term which is designated by the retrieval term inputting means and/or incorporated by the term incorporating means;
a characteristic term display section for displaying a characteristic term extracted by the characteristic term extracting means;
a header display section for displaying a header of one or a plurality of items of information retrieved by the retrieving means; and
a detail display section for displaying details of one or a plurality of items of information retrieved by the retrieving means.

3. An information retrieving apparatus according to claim 2, wherein the retrieval display means is a computer monitor, and
wherein, in a configuration where the retrieval display means is displayed on the computer monitor in a divided manner into substantially right and left sides, the retrieval term display section, the characteristic term display section, and the detail display section are arranged at the upper, intermediate, and lower stages, respectively, in the substantially left side, while the header display section is arranged in the substantially right side.

4. An information retrieving apparatus according to claim 2 or 3, wherein the characteristic term display section has a plurality of columns so that a plurality of characteristic terms can be displayed for each column, and each characteristic term is distributed and displayed in each column for each attribute of the characteristic term.

5. An information retrieving apparatus according to claim 4, wherein an attribute of the characteristic term is part of speech.

6. An information retrieving apparatus according to any one of claims 1 to 5, wherein the information recording medium is at least one of a hard disk, a digital video disk, a compact disk, a floppy disk, a magnetooptical disk, a magnetic tape, a semiconductor memory installed in a server provided on the Internet.

7. An information retrieving apparatus according to any one of claims 1 to 5, wherein the information recording medium is at least one of a hard disk, a digital video disk, a compact disk, a floppy disk, a magnetooptical disk, a magnetic tape, a semiconductor memory installed in the information retrieving apparatus.

8. A storage medium storing an information retrieving software for searcher's retrieving desired information from information recorded in an information recording medium, wherein the information retrieving software comprises:
a retrieval term inputting step;
a characteristic term extracting step of automatically extracting one or a plurality of characteristic terms associated with the retrieval term from the information recording medium;
a characteristic term designating step of searcher's designating at least one of the characteristic terms;
a term incorporating step of incorporating the designated characteristic term into a retrieval term; and
a retrieving step of extracting one or a plurality of items of information retrieved from all the retrieval terms.

9. A storage medium storing an information retrieving software therein according to claim 8, wherein the information retrieving software comprises a retrieval display step of:
displaying a retrieval term which is designated in the retrieval term inputting step and/or incorporated in the term incorporating step in a retrieval term display section;
displaying a characteristic term extracted in the characteristic term extracting step in a characteristic term display section;
displaying a header of one or a plurality of items of information retrieved in the retrieving step in a header display section; and
displaying details of one or a plurality of items of information retrieved in the retrieving means in a detail display section.

10. A storage medium storing an information retrieving software therein according to claim 9, wherein, in a configuration where division display is performed into substantially right and left sides on a computer monitor by the retrieval display step, the retrieval term displays section, the characteristic term display section, and the detail display section are arranged at the upper, intermediate, and lower stages, respectively, in the substantially left side, while the header display section is arranged in the substantially right side.

11. A storage medium storing an information retrieving software therein according to claim 9 or 10, wherein the characteristic term display section has a plurality of columns so that a plurality of characteristic terms can be displayed for each column, and each characteristic term is distributed and displayed in each column for each attribute of the characteristic term.

12. A storage medium storing an information retrieving software therein according to claim 11, wherein an attribute of the characteristic term is part of speech.

13. A storage medium storing an information retrieving software therein according to any one of claims 8 to 12, wherein the information recording medium is at least one of a hard dist, a digital video disk, a compact disk, a floppy disk, a magnetooptical disk, a magnetic tape, a semiconductor memory installed in a server provided on the Internet.

14. A storage medium storing an information retrieving software therein according to claims 8 to 12, wherein the information recording medium is at least one of a hard disk, a digital video disk, a compact disk, a floppy disk, a magnetooptical disk, a magnetic tape, a semiconductor memory installed in an apparatus in which an information retrieving software is introduced.
